(19) United States
(12) Patent Application Publication
(10) Pub. No.: US 2025/0097440 A1
(43) Pub. Date: Mar. 20, 2025

(54) LEARNED IMAGE COMPRESSION AND DECOMPRESSION USING LONG AND SHORT ATTENTION MODULE

(71) Applicant: GUANGDONG OPPO MOBILE TELECOMMUNICATIONS CORP., LTD., Dongguan (CN)

(72) Inventors: Cheolkon JUNG, Dongguan (CN); Zenghui DUAN, Dongguan (CN)

(21) Appl. No.: 18/956,949

(22) Filed: Nov. 22, 2024

Related U.S. Application Data
(63) Continuation of application No. PCT/CN2022/094521, filed on May 23, 2022.

(51) Int. Cl. H04N 19/42; G06V 10/77; G06V 10/80; G06V 10/82; H04N 19/132

(52) U.S. Cl. CPC H04N 19/42; G06V 10/7715; G06V 10/806; G06V 10/82; H04N 19/132

(57) ABSTRACT

A method for feature extraction using a neural network includes: extracting a first set of features from an input set of features by processing said input set of features through at least two residual blocks of the neural network connected successively to each other; extracting a second set of features from the input set of features, said extracting the second set of features comprising the steps of: extracting a third set of features and a fourth set of features from the input set of features by a non-local attention processing, implementing a group convolution by a multi-head attention mechanism to the input set of features, the third set of features and the fourth set of features to obtain the second set of features.

### CROSS-REFERENCE TO RELATED APPLICATION

This application is a Continuation Application of PCT/CN2022/094521 filed May 23, 2022, which is incorporated herein by reference in its entirety.

### TECHNICAL FIELD

The present application relates to the technical filed of compression and decompression of visual information. More specifically, the present application relates to a neural network-based method for feature extraction in learned image compression and decompression using long and short attention module and a device therefor.

### BACKGROUND

Visual information such as for example pictures or images, for example, still pictures (still images) but also moving pictures (moving images) such as picture streams and videos are one of the main media to obtain information. Transmission of still pictures over wired and/or wireless networks but also video transmission and/or video streaming over wired or wireless mobile networks, broadcasting digital television signals, real-time video conversations such as video-chats or video-conferencing over wired or wireless mobile networks and storing of images and videos on portable storage media such as DVD disks or Blue-ray disks is increasingly performed nowadays for, for example, exchange of various information between users.

However, uncompressed images normally consume a lot of resources when saving and transmitting. Therefore, to efficiently store and transmit images, image compression and decompression algorithms become more and more important.

Image compression and decompression involve encoding and decoding respectively. Encoding is the process of compressing and potentially also changing the format of the content of the picture (image). Encoding is important as it reduces the bandwidth needed for transmission of the picture (image) over wired or wireless mobile networks. Decoding on the other hand is the process of decoding or uncompressing the encoded or compressed picture (image). Since encoding and decoding is applicable on different devices, standards for encoding and decoding called codecs have been developed. A codec is in general an algorithm for encoding and decoding of pictures.

As an international standard for image compression, the Joint Photographic Experts Group (JPEG) was established in 1994, which is still one of the most widely used image compression algorithms (see non-patent reference [1]). In addition, a variety of image compression standards such as JPEG2000 (see non-patent reference [2]) and BPG (see non-patent reference [3]) have been released during the past decades. The latest H.266/Versatile Video Coding (VVC) standard, officially released in 2018, represents the most advanced coding technology available (see non-patent reference [4]). Compared with the previous generation standard (H.265/HEVC), H.266 further improves the compression performance to reduce the data size by 50% for users while maintaining video quality. It is still continuously updated and iterated to achieve higher compression efficiency.

As in many other technical fields, deep neural network is being also extensively used in image compression and decompression. The two characteristics of local connection and parameter sharing in convolutional neural network, CNN, operation show its advantages in image compression. Different from traditional methods, CNN-based end-to-end optimization requires the function to be globally differentiable in gradient descent. To solve this problem, Ballé et al. (see non-patent reference [5]) in 2016 proposed a CNN-based image coding framework based on generalized divergence normalization. Its network structure is mainly divided into two parts: One part is responsible for analyzing the latent representation of the image, and the other part is responsible for the reconstruction and inverse process using the generalized divergence normalization function as the activation function. This method achieves encoding performance comparable to JPEG2000.

Later, Ballé et al. (see non-patent reference [6]) combined the super-prior codec with the previous method to further reduce the spatial redundancy between feature maps and improve the compression efficiency.

These two works provide the feasibility of CNN-based image compression. The latest research is an image compression method based on Gaussian mixture model and attention mechanism proposed by Cheng et al. (see non-patent reference [7]) in 2020, which has achieved compression efficiency comparable to VVC on Kodak dataset.

There are two modules in deep learning-based image compression that have a significant impact on bit savings. One is to build a flexible and accurate entropy model to help the network encode and decode simultaneously to save bits, while the other is to extract more accurate latent representations of images in the autoencoder stage, reducing spatial redundancy to save bits.

### CITED REFERENCES

### Non-Patent Literature

NPT 1 Gregory K. Wallace, “The jpeg still picture compression standard,” IEEE transactions on consumer electronics, vol. 38, no. 1, pp. xviii-xxxiv, 1992.
NPT 2 Majid Rabbani and Rajan Joshi, “An overview of the jpeg 2000 still image compression standard,” Signal processing: Image communication, vol. 17, no. 1, pp. 3-48, 2002.
NPL 3 Gary J Sullivan, Jens-Rainer Ohm, Woo-Jin Han, and Thomas Wiegand, “Overview of the high efficiency video coding (hevc) standard,” IEEE Transactions on circuits and systems for video technology, vol. 22, no. 12, pp. 1649-1668, 2012.
NPL 4 Jens-Rainer Ohm and Gary J. Sullivan, “Versatile video coding towards the next generation of video compression,” in Proceedings of the Picture Coding Symposium, 2018, vol. 2018.
NPL 5 Johannes Balle, Valero Laparra, and Eero P. Simoncelli, “End-to-end optimized image compression,” ar Xiv preprint arXiv:1611.01704, 2016.
NPL 6 Johannes Balle, David Minnen, Saurabh Singh, Sung Jin Hwang, and Nick Johnston, “Variational image compression with a scale hyperprior,” arXiv preprint arXiv:1802.01436, 2018.
NPL 7 Zhengxue Cheng, Heming Sun, Masaru Takeuchi, and Jiro Katto, “Learned image compression with discretized gaussian mixture likelihoods and attention modules,” in Proceedings of the IEEE/CVF Conference on Computer Vision and Pattern Recognition, 2020, pp. 7939-7948.
NPL 8 Jean Begaint, Fabien Racape, Simon Feltman, and Akshay Pushparaja, “Compressai: a pytorch library and evaluation platform for end-to-end compression research,” arXiv preprint arXiv:2011.03029, 2020
NPL 9 David Minnen, Johannes Balle, and George D. Toderici, “Joint autoregressive and hierarchical priors for learned image compression,” Advances in neural information processing systems, vol. 31, 2018

### Technical Problem

However, traditional image compression is very complex in the coding stage. In the intra-prediction module of H.266/VVC, 67 prediction modes need to be tried to find the most suitable one for the current coding unit (CU). For example, in the traditional coding method different coding methods for each coding unit (CU) of the image need to be used, which increases the complexity of image compression while reducing the bit rate. Most of the deep learning methods based on the end-to-end network structure use the same coding structure as Ballé et al.'s work (see non-patent reference [5]). The current methods for deep learning-based image compression mainly focus on building an accurate and flexible entropy model, while ignoring the accurate extraction of the latent representation of the image at the encoding end.

Therefore, there is a need to improve the accurate extraction of the latent representation of the image at the encoding end.

### SUMMARY

The mentioned problems and drawbacks are addressed by the subject matter of the independent claims. Further preferred embodiments are defined in the dependent claims. Specifically, embodiments of the present application provide substantial benefits regarding increasing efficiency by saving bitrates in image compression.

According to a first aspect of the present application there is provided a method for feature extraction using a neural network, the method including:
extracting a first set of features from an input set of features by processing said input set of features through at least two residual blocks of the neural network connected successively to each other;
extracting a second set of features from the input set of features, said extracting the second set of features including the steps of:
extracting a third set of features and a fourth set of features from the input set of features by a non-local attention processing, and
implementing a group convolution by a multi-head attention mechanism to the input set of features, the third set of features and the fourth set of features to obtain the second set of features.

According to a second aspect of the present application there is provided a method for learned image compression using a neural network, the method including performing the steps of:
extracting a set of features (x) from an input image data to be compressed; and
extracting a set of features (y) indicating a latent representation of the input image data to be compressed from the set of features (x) extracted from the input image data to be compressed by performing the steps of:
performing at least four steps of downsampling convolution processing by at least four convolutional layers of the neural network arranged in a stream like manner on the extracted set of features (x) from the input image data, and
performing the steps of the feature extraction according to the above described first aspect at least once after two steps of downsampling convolution processing by two convolutional layers from the at least four convolutional layer by using as the input set of features a set of features based on the output of the second convolutional layer from the two convolutional layers to thereby extract the set of features (y) indicating the latent representation of the input image data; and
the method further including the step of:
outputting the extracted set of features (y) indicating a latent representation of the input image data.

According to a third aspect of the present application there is provided a method for learned image decompression using a neural network, the method including:
extracting a set of features from an input set of features to be decompressed; and
extracting a set of features indicating a reconstructed image of the input image data from the extracted set of features by performing the steps of:
performing the steps of the feature extraction method in the first aspect using as the input set of features the extracted set of features from the input set of features to be decompressed,
performing upsampling convolution processing by at least four convolutional layers of the neural network arranged in a stream like manner on the extracted set of features from the input set of features to be decompressed, and
performing the feature extraction according to the above described first aspect at least once after two steps of upsampling convolution processing by two convolutional layers from the at least four convolutional layer by using as the input set of features a set of features based on the output of the second convolutional layer from the two convolutional layers to thereby extract a set of features indicating a reconstructed image of the input image data; and
the method further including:
outputting the extracted set of features indicating a reconstructed image of the input image data.

According to a fourth aspect of the present application there is provided a method of learned image processing using a neural network, the method including:
performing the steps of the above described second aspect;
providing the outputted extracted set of features (y) indicating a latent representation of the input image data in a first processing path and a second processing path, wherein:
in the first processing path performing the steps of: acquiring (or learning) a modeling information by a hyper encoder from the provided set of features indicating a latent representation,
quantizing the modeling information by a quantizer, and
acquiring a decoded information by a hyper decoder from the quantized modeling information, wherein in the second processing path performing the steps of:
obtaining an auxiliary information by a context model from a quantized latent representation indicating a latent representation quantized by a quantizer,
calculating modeling parameters by an entropy model by combining the decoded information and the auxiliary information, and
calculating an output of an entropy decoder from the modeling parameters; and the method further including the step of:
generating a reconstructed image by the image decompression method of the above described third aspect using as an input set of features to be decompressed the output of the entropy decoder.

According to a fifth aspect of the present application there is provided an encoder for image data compression, said encoder including:
a first downsampling processing means for downsampling processing an input set of features obtained from an input image data;
a first filter means for extracting a set of mixed features from an output of the first downsampling processing means, said mixed features including local and global features;
a second downsampling processing means for downsampling processing said extracted set of mixed features; and
a second filter means for extracting latent representation of the input image data from an output of the second downsampling processing means for downsampling.

According to a sixth aspect of the present application there is provided a decoder for image data decompression, said decoder including:
a first filter means for extracting features from an input set of features to be decompressed;
a first upsampling processing means for upsampling processing the set of features output from the first filter means the prefilter;
a second filter means for extracting features from a set of features output from the first upsampling processing means; and
a second upsampling processing means for upsampling processing the set of features output from the second filter means to obtain a set of features representing a reconstructed image of the input set of features.

### BRIEF DESCRIPTION OF THE DRAWINGS

Embodiments of the present application, which are presented for better understanding the inventive concepts, but which are not to be seen as limiting the application, will now be described with reference to the figures in which:

FIG. 1A shows a schematic view of general use case as an environment for employing embodiments of the present application;

FIG. 1B shows a schematic view of the long and short attention module extracting local and global features according to an embodiment of the present application;

FIG. 1C shows a flowchart of a method embodiment of the present application for feature extraction;

FIG. 2 shows a schematic view of the group convolution performed in the global feature extraction in the long and short attention module;

FIG. 3 shows a schematic view of a residual block in the embodiments of the present application;

FIG. 4A shows a schematic view of a framework of the deep learning-based image compression and decompression according to an embodiment of the present application;

FIG. 4B shows a schematic view of a neural network structure of the deep learning-based image compression and decompression shown in FIG. 4A;

FIG. 5A shows schematically a neural network structure of an encoder of the proposed learned image compression according to an embodiment of the present application;

FIG. 5B shows schematically a neural network structure of a decoder of the proposed learned image decompression according to an embodiment of the present application;

FIG. 5C shows a flowchart of a device embodiment of the encoder of the proposed learned image compression;

FIG. 5D shows a flowchart of a device embodiment of the decoder of the proposed learned image decompression;

FIG. 6 shows a schematic view of a file format of a bitstream obtained by the image compression method according to an embodiment of the present application;

FIG. 7 shows a general device embodiment of the present application;

FIG. 8 shows schematically a pipeline of a testing procedure for acquiring quality scores of the proposed learned image compression and decompression according to an embodiment of the present application;

FIG. 9 shows visual comparison among different methods in 00001-TE-960×720 of JPEG AI dataset;

FIGS. 10A & 10B show rate-distortion curves to compare codec performances between different methods; and

FIG. 11 shows a table of average bitrate savings over five A in comparison with VVC (VTM 15.0) anchor.

### DETAILED DESCRIPTION

To address the above-described drawback of the current methods for deep learning-based image processing the present application proposes improving the feature extraction ability of the encoder and the reconstruction ability of the decoder to thereby improve the compression performance of the network. For this, the present application proposes method for feature extraction using a neural network. The steps of the method are performed using the proposed architecture of the neural network described here below which is here below called a long and short attention module for feature extraction.

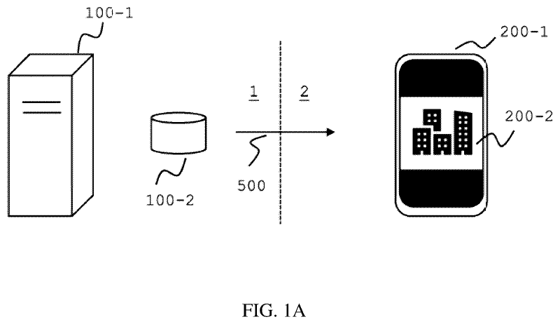

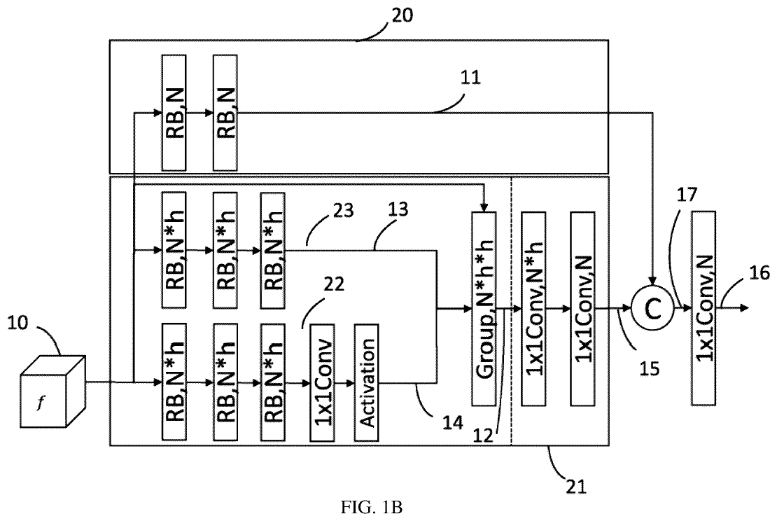

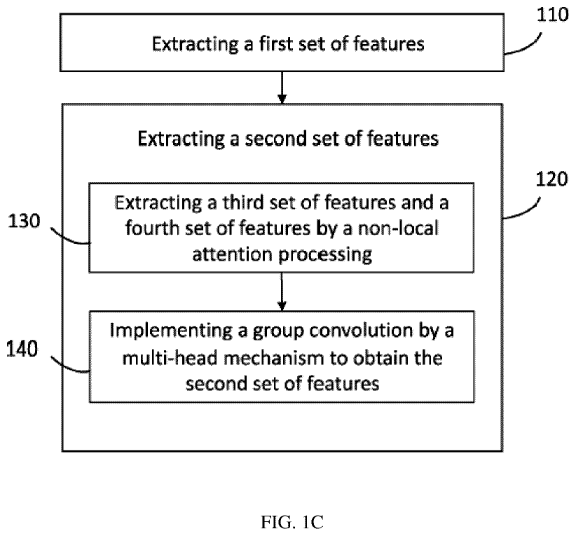

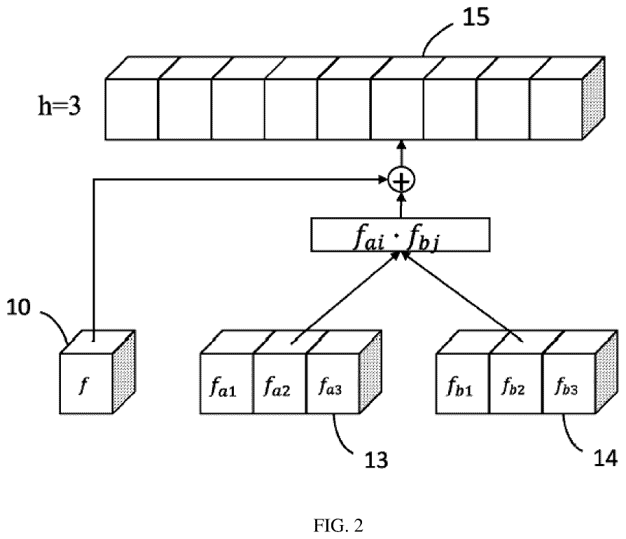

FIG. 1A shows a schematic view of a general use case as an environment for employing embodiments of the present application. On the encoding side 1 there is arranged equipment 100-1, 100-2, such as data centres, servers, processing devices, data storages and the like that is arranged to store and process image data and generate one or more bitstreams by encoding the image data.

Generally, the term image data in the context of the present disclosure shall include all data that contains, indicates and/or can be processed to obtain an image, a picture, a stream of pictures/images, a video, a movie, and the like, wherein, in particular, a stream, video or a movie may contain one or more images. Such data may also be called a visual data.

The image data may be monochromatic including grey scale information or may include colour information. Normally, each image is captured by at least one image capturing unit to thereby obtain the image data.

On the encoding side 1, the one or more generated bitstreams are conveyed 500 via any suitable network and data communication infrastructure toward the decoding side 2, where, for example, a terminal such as a mobile device 200-1 is arranged that receives the one or more bitstreams, decodes them and processes them to generate the reconstructed image data for displaying it on a display 200-2 of the (target) mobile device 200-1 or subjects them to other processing.

In a first clause, the present application provides a method for feature extraction using a neural network, which includes:
extracting a first set of features from an input set of features by processing said input set of features through at least two residual blocks of the neural network connected successively to each other;
extracting a second set of features from the input set of features, said extracting the second set of features including the steps of:
extracting a third set of features and a fourth set of features from the input set of features by a non-local attention processing,
implementing a group convolution by a multi-head attention mechanism to the input set of features, the third set of features and the fourth set of features to obtain the second set of features.

In a second clause, according to the first clause, the input set of features is a multidimensional vector representing an image data.

In a third clause, according to the second clause, the first set of features is a set of local features of the image data and the second set of features is a set of global features of the image data.

In a fourth clause, according to any one of the first to the third clause, the method further includes the steps of:
obtaining a fifth set of features by processing the second set of features by at least two convolutional layers of the neural network.

In a fifth clause, according to any one of the first to the fourth clause, the method further includes the steps of:
performing cascading processing on the first set of features and the fifth set of features, and
fusing the first set of features and fifth set of features after cascading processing to thereby obtain a mixed set of features.

In a sixth clause, according to the fifth clause, the method further includes:
performing convolution processing on the mixed set of features by at least one convolutional layer of the neural network to obtain a sixth set of features, and
outputting the sixth set of features.

In a seventh clause, according to any one of the first to the sixth clause, the implementing the group convolution includes the steps of:
multiplying the third set of features and the fourth set of features,
adding the input set of features to the multiplication of the third set of features and the fourth set of features to obtain a resultant set of features, and
concatenating the resultant set of features by the number of heads of the multi-head attention mechanism to obtain the second set of features.

In an eighth clause, according to any one of the first to the seventh clause, the extracting the third set of features includes:
processing the input set of features through at least three residual blocks of the neural network successively connected to each other.

In a ninth clause, according to any one of the first to the eighth clause, the extracting the fourth set of features includes:
processing the input set of features by at least three residual blocks of the neural network successively connected to each other;
processing the output of the last of the at least three residual blocks by a convolutional layer of the neural network; and
performing activation processing by an activation layer of the neural network to the output of the at least one convolutional layer;

In a tenth clause, the present application provides a method for learned image compression using a neural network, which includes performing the steps of:
extracting a set of features (x) from an input image data to be compressed; and
extracting a set of features (y) indicating a latent representation of the input image data to be compressed from the set of features (x) extracted from the input image data to be compressed by performing the steps of:
performing at least four steps of downsampling convolution processing by at least four convolutional layers of the neural network arranged in a stream like manner on the extracted set of features (x) from the input image data, and
performing the steps of the feature extraction method in the first clause at least once after two steps of downsampling convolution processing by two convolutional layers from the at least four convolutional layer by using as the input set of features a set of features based on the output of the second convolutional layer from the two convolutional layers to thereby extract the set of features (y) indicating the latent representation of the input image data; and
the method further includes the step of:
outputting the extracted set of features (y) indicating a latent representation of the input image data.

In an eleventh clause, according to the tenth clause, the method further includes:
inserting a step of processing by at least one residual block of the neural network at least between two steps of downsampling processing by two convolutional layers of the at least four downsampling convolutional layers arranged in a stream like manner.

In a twelfth clause, the present application provides a method for learned image decompression using a neural network, which includes:
extracting a set of features from an input set of features to be decompressed; and
extracting a set of features indicating a reconstructed image of the input image data from the extracted set of features by performing the steps of:
performing the steps of the feature extraction method in the first clause using as the input set of features the extracted set of features from the input set of features to be decompressed,
performing upsampling convolution processing by at least four convolutional layers of the neural network arranged in a stream like manner on the extracted set of features from the input set of features to be decompressed, and
performing the feature extraction method in the first clause at least once after two steps of upsampling convolution processing by two convolutional layers from the at least four convolutional layer by using as the input set of features a set of features based on the output of the second convolutional layer from the two convolutional layers to thereby extract a set of features indicating a reconstructed image of the input image data; and
the method further includes:
outputting the extracted set of features indicating a reconstructed image of the input image data.

In a thirteenth clause, according to the twelfth clause, the method further includes:
inserting a step of processing by at least one residual block of the neural network at least once between two steps of upsampling processing by two convolutional layers of the at least four upsampling convolutional layers arranged in a stream like manner.

In a fourteenth clause, according to any of the first to the thirteenth clause, the performing the step of processing by a residual block includes:
performing convolution by at least two convolutional layers of the neural network;
performing activation by at least one activation layer of the neural network after each of the at least two convolutional layers of the neural network;
implementing a skip connection providing an alternative path from an input of the residual block to an output of the residual block; and
obtaining the output of the residual block by fusing the skip connection and the last activation layer of the residual block.

In a fifteenth clause, the present application provides a method for learned image processing using a neural network, which includes:
performing the steps of the method in the ninth clause;
providing the outputted extracted set of features (y) indicating a latent representation of the input image data in a first processing path and a second processing path, where:
in the first processing path performing the steps of:
acquiring a modeling information by a hyper encoder from the provided set of features indicating a latent representation,
quantizing the modeling information by a quantizer, and
acquiring a decoded information by a hyper decoder from the quantized modeling information,
in the second processing path performing the steps of:
obtaining an auxiliary information by a context model from a quantized latent representation indicating a latent representation quantized by a quantizer,
calculating modeling parameters by an entropy model by combining the decoded information and the auxiliary information, and
calculating an output of an entropy decoder from the modeling parameters; and the method further includes the step of:
generating a reconstructed image by the image decompression method defined in the eleventh clause using as an input set of features to be decompressed the output of the entropy decoder.

In a sixteenth clause, the present application provides a data processing apparatus for feature extraction including processing resources and an access to a memory resource to obtain code that instructs said processing resources during operation to carry out the method in the first clause.

In a seventh clause, the present application provides a computer program including instructions which, when program is executed by a computer, cause the computer to carry out the method in the first clause.

In an eighteenth clause, the present application provides a non-transitory computer readable storage medium including instructions which, when executed by a computer, cause the computer to carry out the method in the first clause.

In a nineteenth clause, the present application provides an encoding apparatus for learned image compression including processing resources and an access to a memory resource to obtain code that instructs said processing resources during operation to carry out the method in the ninth clause.

In a twentieth clause, the present application provides a computer program including instructions which, when program is executed by a computer, cause the computer to carry out the method in the tenth clause.

In a twenty-first clause, the present application provides a non-transitory computer readable storage medium including instructions which, when executed by a computer, cause the computer to carry out the method in the tenth clause.

In a twenty-second clause, the present application provides a decoding apparatus for learned image decompression including processing resources and an access to a memory resource to obtain code that instructs said processing resources during operation to carry out the method in the twelfth clause.

In a twenty-third clause, the present application provides a computer program including instructions which, when program is executed by a computer, cause the computer to carry out the method in the twelfth clause.

In a twenty-fourth clause, the present application provides a non-transitory computer readable storage medium including instructions which, when executed by a computer, cause the computer to carry out the method in the twelfth clause.

In a twenty-fifth clause, the present application provides a system including one or more processing resources and an access to one or more memory resources to obtain one or more codes that instructs said one or more processing resources during operation to carry out the method in the fifteenth clause.

In a twenty-sixth clause, the present application provides an encoder for image data compression, which includes:
a first downsampling processing means for downsampling processing an input set of features obtained from an input image data;
a first filter means for extracting a set of mixed features from an output of the first downsampling processing means, said mixed features including local and global features;
a second downsampling processing means for downsampling processing said extracted set of mixed features; and
a second filter means for extracting latent representation of the input image data from an output of the second downsampling processing means for downsampling.

In a twenty-seventh clause, the present application provides a decoder for image data decompression, which includes:
a first filter means for extracting features from an input set of features to be decompressed;
a first upsampling processing means for upsampling processing the set of features output from the first filter means the prefilter;
a second filter means for extracting features from a set of features output from the first upsampling processing means; and
a second upsampling processing means for upsampling processing the set of features output from the second filter means to obtain a set of features representing a reconstructed image of the input set of features.

FIG. 1C shows a flowchart of a general method embodiment of the present application for feature extraction using a neural network. More specifically, the method includes a step (110) of extracting a first set of features from an input set of features by processing said input set of features through at least two residual blocks of the neural network connected successively to each other, and a step (120) of extracting a second set of features from the input set of features. The step (120) of extracting the second set of features includes a step (130) of extracting a third set of features and a fourth set of features from the input set of features by a non-local attention processing, and a step (140) of implementing a group convolution by a multi-head attention mechanism to the input set of features, the third set of features and the fourth set of features to obtain the second set of features.

FIG. 1B shows a schematic view of the long and short attention module for performing the steps of the method for feature extraction using a neural network according to the embodiment of the present application. In relation to FIG. 1A described general use case, the embodiments of the present application further below are described in the context of image data coding and decoding. However, this is by no way limiting and the present application may also be applied to, for example, language modeling and machine translation or speech recognition.

FIG. 1B shows the schematic view of the long and short attention module in terms of the architecture of the neural network for performing the steps of the method for feature extraction according to the embodiment of the present application and the corresponding processing. The neural network can be, for example, a deep neural network which consists of at least two layers in its structure. Accordingly, it is to be understood that the term “module” is used to represent the architecture of the neural network for carrying out the steps of the method for feature extraction of the embodiment of the present application. In FIG. 1B and in other figures to be described, “N” is a number of channels of the neural network and “h” is a number of heads of a multi-head attention mechanism to be described later. In the context of image data coding and decoding the extracted features may be small patches in the image data. In this context, each feature normally includes a feature key point and a feature descriptor. The feature key point may represent the patch 2D position. The feature descriptor may represent visual description of the patch. The feature descriptor is generally represented as a vector, also called a feature vector. As will be elaborated above, at least some of the steps of processing by the long and short attention module shown in FIG. 1B are optional and not limiting to the present application.

The long and short attention module extracts a first set of features 11 (Step 110 in FIG. 1C) and a second set of features 12 (Step 120 in FIG. 1C) from an input set of features 10. The first set of features 11 is extracted from the input set of features by processing said input set of features through at least two residual blocks of the neural network connected successively to each other. It is to be understood that more than two residual blocks connected successively to each other may also be used in other embodiments of the present application.

The input set of features 10 may be any type of set of features whose size and data type fit to the neural network structure of the long and short attention module of the embodiment of the present application. The input set of features 10 is not limited to a specific data type, thus the feature extraction performed by the long and short attention module can be used on versatile data types. By way of example, the data type may be image data.

In one embodiment of the present application, the input set of features 10 is a multidimensional vector representing an image data. For example, the feature extraction method for learned image processing according to the present application may be applied in image encoding and/or image decoding as elaborated further below. Therefore, the input set of features 10 being a multidimensional vector representing an image data is to be understood as the input set of features directly or indirectly representing the image data, for example it may directly represent the image data or may indirectly represent the image data by representing for example the latent representation of an encoded image.

In general, an attention in deep learning can be described as a function mimicking cognitive attention which gives more focus on more important parts of the data. The attention overcomes limitation of general encoder-decoder architecture which has a fixed-length internal representation.

The extraction of the first set of features 11 and the second set of features 12 are each shown in the upper 20 and lower 21 branch of the long and short attention module of FIG. 1B.

In one embodiment of the present application, the extracted first set of features 11 may be a set of local features of the image data and the extracted second set of features may be a set of global features of the image data.

Accordingly, in one embodiment of the present application, the upper branch 20 of FIG. 1B may extract a set of local features while the lower branch 21 of FIG. 1B may extract a set of global features. More specifically, the lower branch 21 of FIG. 1B may extract a set of multi-scale global features. Then, the long and short attention module according to the present application represented in the FIG. 1B fuses the extracted first set of features 11 and the extracted second set of features 12.

In one embodiment of the present application in which the upper branch 20 of FIG. 1B extracts a set of local features while the lower branch 21 of FIG. 1B extracts a set of global features the long and short attention module according to the embodiment of the present application may fuse the extracted local and global features to get accurate latent features of the image data.

As elaborated above with respect to the general method embodiment of the present application, the step 120 of extracting the second set of features includes a step 130 of extracting a third set of features and a fourth set of features from the input set of features by a non-local attention processing and a step 140 of implementing a group convolution by a multi-head attention mechanism to the input set of features, the third set of features and the fourth set of features to obtain the second set of features.

For this, the first half of the lower branch 21 of the long and short attention module shown in FIG. 1B represents a simplified non-local attention module. The non-local attention module includes two paths based on stacked network architecture and residual block architecture. From the input set of features 10, the simplified non-local attention module extracts a third set of features 13 in the upper path 23 by performing processing by at least three residual blocks connected successively to each other. FIG. 1B shows the long and short attention module as including three residual blocks in the upper path 23, however, this is not limiting to the present application and more than three residual blocks connected successively to each other may be used. However, using a higher number of residual blocks may affect the calculation time and the processing resources.

From the input set of features 10, the simplified non-local attention module extracts a fourth set of features 14 in the lower path 22. For extracting the fourth set of features 14 the long and short attention module according to the embodiment of the present application in the lower path 22 uses a neural network architecture based on at least three residual blocks connected successively to each other, at least one convolutional layer following after the last of the at least three residual blocks and at least one activation layer following after the at least one convolutional layer.

In FIG. 1B it is shown the short and long attention module as extracting the fourth set of features 14 by three residual blocks as also used in the extraction of the third set of features 13 in the upper path 23 and additional one convolutional layer and an activation layer is used. However, the number of residual blocks may be more than three as well as the number of convolutional layers and activation layers in the lower path 22 may be more than one. Also, the number of residual blocks in the upper path 23 does not have to be the same as the number of residual blocks in the lower path 22.

By having an activation function applied by the activation layer on the lower path 22 for extracting the fourth set of features 14, it may be possible to achieve more complex calculation by adding nonlinearity. By applying the activation function, the fourth set of features 14 may have values between 0 and 1. By way of example the fourth set of features 14 may be considered to represent the weights of the third set of features 13. However, the values of the fourth set of features 14 are not limited to values between 0 and 1 and may vary depending on the specific activation function applied.

As a result, it may be possible to distinguish features which have less complex features, thus may be interpreted less globally and features which may be more complex features, thus may need to be interpreted as global features in each of the third set of features 13 and the fourth set of features 14.

An activation layer can be for example one of rectified linear unit (ReLU), leakyReLU, Sigmoid, Tan h, Softmax or any other activation function. The activation function may add nonlinearity in the neural network and may enable the neural network to solve computationally more complex tasks.

As a convolutional layer of the neural network a convolutional layer which has a filter size of 1×1 may be used.

Once the third set of features 13 and the fourth set of features 14 are extracted, a group convolution is implemented by a multi-head attention mechanism to the extracted third set of features 13, fourth set of features 14 and the input set of feature 10 to obtain the second set of features 12 (Step 140 in FIG. 1C). In the group convolution, the input set of features 10, which uses skip connections without processing, the third set of features 13, whose ability of extracting fields may be increased compared to the input set of features 10 by processing through the residual blocks, and the fourth set of features 14, which may be able to extract more complex features compared to the third set of feature 13 by the additional activation layer are incorporated to thereby obtain the second set of features 12. In other words, these three sets of features to which group convolution is implemented may contain features in different scales and thus they enable extraction of the multi-scale global features. Therefore, the second set of features 12 may contain global features of the input of the long and short attention module.

The upper branch 20 for extracting the first set of features 11 and the lower branch 21 for extracting the second set of features 12 may be then fused into mixed feature map.

As elaborated above, in the long and short attention module according to the embodiment of the present application the first set of features 11 is extracted by at least two residual blocks of the neural network successively connected to each other to directly extract the set of local features. Meanwhile, the second set of features 12, which in one embodiment of the present application may represent the global features, may be extracted by processing through the non-local attention module and the multi-head attention mechanism through the group convolution as elaborated above. The group convolution incorporates the input set of features 10, the third set of features 13, and the fourth set of features 14, thereby generating the second set of features from the input set of features 10.

The extracted second set of features 12 may be further processed to obtain a fifth set of features 15 by at least two convolutional layers of the neural network. This processing may enable reducing dimensions of the second set of features 12 to obtain the fifth set of features 15, as shown in the lower branch 21 of the FIG. 1B. With this processing, the dimensions of the fifth set of features 15 may match the dimensions of the first set of features 11.

Further, the long and short attention module may perform cascading processing, once the first set of features 11 and the fifth set of features 15 are obtained and their dimensions match to each other. The first set of features 11 and the fifth set of features 15 are then fused to a multidimensional vector representing thereby mixed set of features 17 that is suitable to be inputted to a next processing step. For example, the next processing step may be a step in an encoding process as elaborated further below.

In the above description, the process of obtaining the second set of features 12 and accordingly the fifth set of features 15 from the input set of features 10 is called long attention, because the second set of features 12 and accordingly the fifth set of features 15 contains global features. The process of obtaining the first set of features 11 from the input set of features 10 is called short attention, and the first set of features 11 only contains local features.

Further, the method for feature extraction according to an embodiment of the present application may include performing convolution processing on the mixed set of features 17 by at least one convolutional layer of the neural network to obtain a sixth set of features 16 as shown in FIG. 1B, which may represent an output of the long and short attention module, however, this step is entirely optional.

FIG. 2 shows a schematic view of the group convolution performed by the multi-head attention mechanism in the global feature extraction in the long and short attention module of the embodiment of the present application. The multi-head attention mechanism can be implemented by the following equation:

$${f}_{out} = {concat}_{0 < i , j \leq h} ( {f}_{a i} \cdot {f}_{b j} + f )$$

where f represents the input set of features 10, fₐᵢ and f_{bi} are two sets of features extracted inside the long and short attention module, which in the above described embodiment are the third set of features 13 and the fourth set of features 14 respectively. h, representing the number of heads of the multi-head attention mechanism, is determined to be 3 for illustrative purpose only, but is not limited to any specific number.

In detail, for the group convolution, the third set of features (fₐᵢ) 13 and the fourth set of features (f_{bi}) 14 are multiplied. After that, the input set of features 10 is added to the multiplication of the third set of features (fₐᵢ) 13 and the fourth set of features (f_{bi}) 14 to obtain a resultant set of features. Then, the resultant set of features is concatenated by the number of heads of the multi-head attention mechanism h to obtain the second set of features 12.

When using an activation function applied by the activation layer to normalize the fourth set of features (f_{bi}) 14 so that the fourth set of features (f_{bi}) 14 has values between 0 and 1 as described above, in the group convolution, since the fourth set of features (f_{bi}) 14 has values between 0 and 1, with the multiplication of the third set of features (fₐᵢ) 13 and the fourth set of features (f_{bi}) 14, important features of the third set of features (fₐᵢ) 13 can be extracted.

As elaborated above, the extraction of the third set of features 13 as well as the extraction of the fourth set of features includes processing through at least three residual blocks for each one of the extracting of the third set of features 13 and the fourth set of features 14. Further, as elaborated above, the extraction of the first set of features 11 includes processing through at least two residual blocks of the neural network.

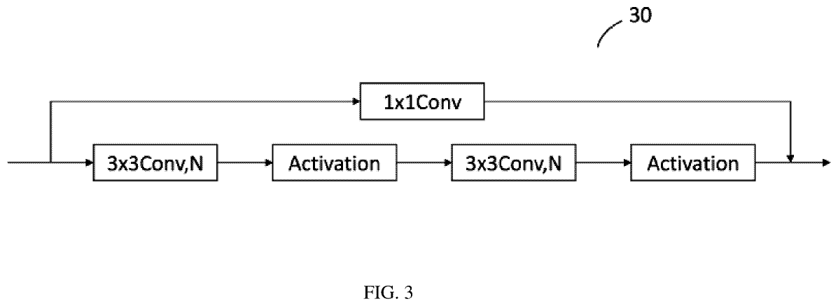

In the embodiments of the present application, each of the residual blocks or at least one of the residual blocks may be defined as the residual block depicted in FIG. 3. For example, the residual block may consist of at least two convolutional layers of the neural network and at least two activation layers each applied after each of the at least two convolutional layers. Furthermore, there may be a skip connection which connects an input and an output of the residual block, thus passing gradients directly to a deeper layer of the neural network without passing through the activation functions (activation layers).

The use of the residual blocks in the present application can expand the receptive filed of the neural network and improve its ability of extracting features.

In the current embodiment of the present application shown in FIG. 3, the skip connection may be implemented by a convolutional layer of the neural network which has a filter size of 1×1. By having the filter size of 1×1, the skip connection may provide an alternative path to a deeper layer of the neural network.

On the lower branch of the residual block as depicted in FIG. 3, the convolutional layers may have filter sizes that are bigger than 1×1. For example, the filter size may be 3×3 and enable to learn relations between neighboring pixels of a target image.

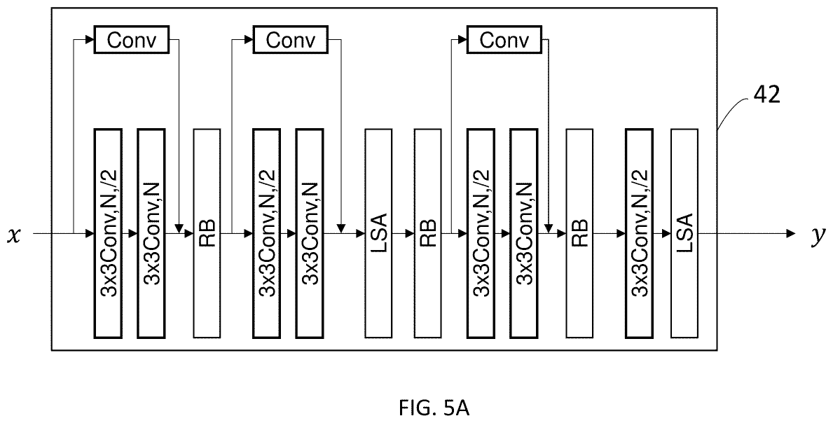

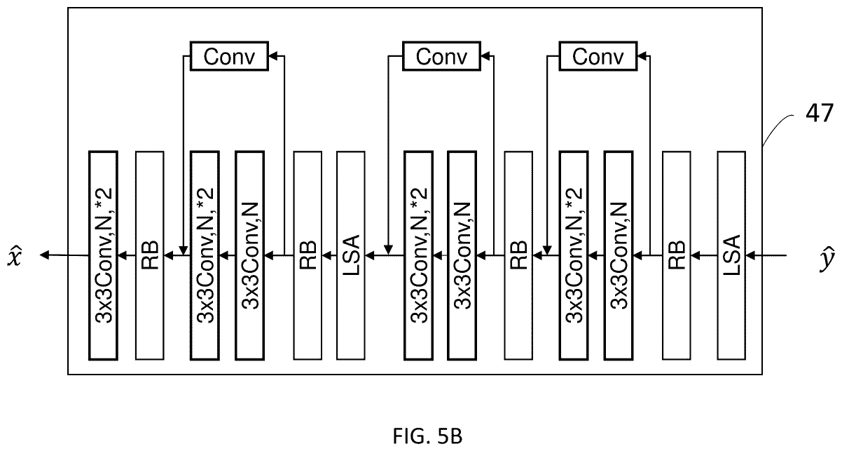

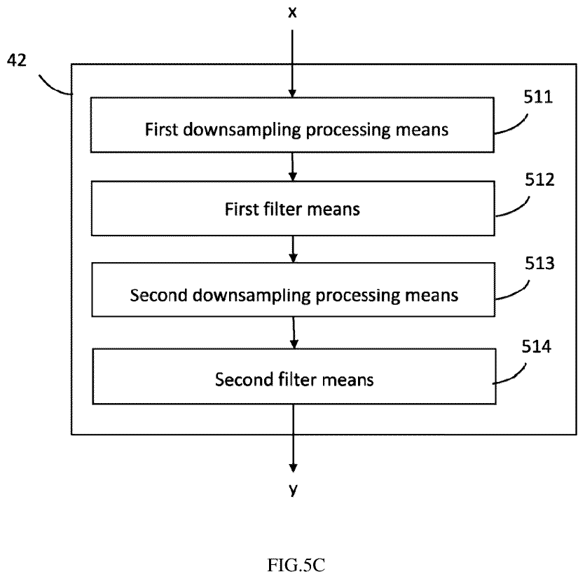

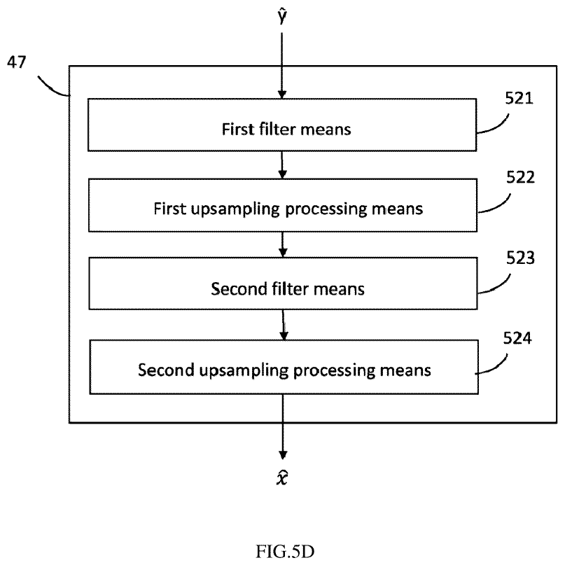

According to the present application there is further provided a method for learned image compression using a neural network. FIG. 5A shows schematically a neural network structure of an encoder 42 for carrying out the steps of the proposed method for learned image compression according to an embodiment of the present application.

According to the method for learned image compression using a neural network of the embodiment of the present application a set of features x from an input image data to be compressed is extracted and a set of features y indicating a latent representation of the input image data to be compressed is extracted from the set of features x extracted from the input image data to be compressed.

The extraction of the set of features y indicating the latent representation of the input image data is performed based on the following steps. The extracted set of features x from the input image data is downsampled by at least four convolutional layers of the neural network arranged in a stream like manner. For example, the extracted set of features x may be reduced in half in its size at each downsampling processing at the corresponding convolutional layer of the at least four convolutional layers of the neural network.

Downsampling in the neural network may be achieved by a downsampling convolutional layer (3×3Conv,N,/2) as depicted in FIG. 5A. The downsampling layer may be used to reduce height and width of feature maps of the neural network. For example, the height and the width of the feature map may be reduced in half by a downsampling processing. The downsampling may be achieved by selecting bigger stride in a convolutional layer, configuring a pooling layer in the neural network or in some other ways.

Then, the long and short attention module as elaborated above is applied at least once after two steps of the downsampling convolution processing from the at least four convolutional layer by using as the input set of features in the long and short attention module a set of features based on the output of the second convolutional layer from the two convolutional layers to thereby extract the set of features (y) indicating the latent representation of the input image data.

The encoder 42 depicted in FIG. 5A may process in each step of downsampling convolutional processing the input image data to be compressed by a downsampling convolutional layer or a downsampling convolutional block. The downsampling convolutional block may consist of the downsampling convolutional layer (3×3Conv,N,/2) and at least one further convolutional layer (3×3Conv,N) which receives an output of the downsampling convolutional layer as its input. These convolutional layers may have filter sizes of 3×3 but the present application is not limited to a certain filter size. Further, the downsampling convolutional block may contain a skip connection which directly connects the input and the output of the downsampling convolutional block by at least one convolutional layer (i.e. Conv). The downsampling convolutional block may be then followed by at least one residual block and a further downsampling convolutional block or a downsampling convolutional layer. The long and short attention module described above may be then applied to the output of the second downsampling convolutional block or downsampling convolutional layer to extract the mixed features.

After the long and short attention module is applied, the residual block, the downsampling convolutional block, another residual block and at least one convolutional layer may be applied before another long and short attention module is applied to extract the latent representation of the input image. The convolutional layer that is applied before the second long and short attention module may be a downsampling convolutional layer with a filter size of 3×3.

In other words, the present embodiment further includes inserting a step of processing by at least one residual block of the neural network at least between two steps of downsampling processing by two convolutional layers of the at least four downsampling convolutional layers arranged in a stream like manner. The term stream like manner is to be understood in the sense that the output of the processing with one downsampling convolutional layer forms the basis for the input fed to the next downsampling convolutional layer. In FIG. 5A the term “stream like manner” may also be understood as “downstream” from the input side of the encoder to the output side of the encoder. The term “forms the basis” is to be understood in the sense that further processing steps may be inserted between the processing with the downsampling convolutional layers. Such processing may be, for example, with a residual block. As elaborated above, the use of a residual block increases the receptive field and improves the rate-distortion performance.

When the set of features indicating the latent representation of the input image data is extracted, the method for learned image compression outputs the extracted set of features y.

According to the present application there is further provided a method for learned image decompression using a neural network. FIG. 5B shows schematically a neural network structure of a decoder 47 for carrying out the steps of the proposed method for learned image decompression according to the embodiment of the present application.

The present embodiment extracts a set of features from an input set of features (ŷ) to be decompressed and extracts a set of features indicating a reconstructed image of the input image data from the extracted set of features.

To extract the set of features indicating the reconstructed image of the input image of the input image data, the feature extraction method by the long and short attention module elaborated above is performed on the extracted set of features from the input set of features to be decompressed. Once the features are extracted by the long and short attention module, upsampling convolution is performed by at least four convolutional layers of the neural network arranged in a stream like manner on the extracted set of features from the input set of features to be decompressed. Then, the feature extraction by the long and short attention module is performed at least once after two steps of upsampling convolution processing by two convolutional layers from the at least four convolutional layer by using as the input set of features a set of features based on the output of the second convolutional layer from the two convolutional layers to thereby extract a set of features indicating a reconstructed image of the input image data.

The term “stream like manner” is to be understood in the sense that the output of the processing with one upsampling convolutional layer forms the basis for the input fed to next upsampling convolutional layer. In FIG. 5B this may be an upstream from the input side of the decoder (right side of the figure) to the output side of the decoder (left side of the figure). The term “forms the basis” is to be understood in the sense that further processing steps may be inserted between the processing with the upsampling convolutional layers. Such further processing may involve for example processing with a residual block as elaborated above.

When the set of features indicating a reconstructed image of the input image data is extracted, the method for learned image decompression of the present embodiment then outputs the extracted set of features.

Upsampling in the neural network can be understood a similar manner to the downsampling. The upsampling may be achieved by an upsampling convolutional layer (3×3Conv,N,*2) or upsampling convolutional block including an upsampling convolutional layer (3×3Conv,N,*2) and at least one further convolutional layer (3×3Conv,N) as depicted in FIG. 5B. Further, the upsampling convolutional block may contain a skip connection which directly connects the input and the output of the upsampling convolutional block by at least one convolutional layer (i.e. Conv). The upsampling convolutional layer may be used to increase height and width of feature maps of the neural network.

In one embodiment of the present application, the method for learned image decompression further includes inserting a step of processing by at least one residual block of the neural network at least once between two steps of upsampling processing by two convolutional layers of the at least four upsampling convolutional layers arranged in a stream like manner.

The residual blocks described for the encoder and the decoder may have the same structure as the residual block described with reference to FIG. 3.

FIG. 5C shows a flowchart of an encoder for image data compression according to the embodiment of the present application. The encoder 42 may extract the latent representation of the input image data. The encoder 42 includes a first downsampling processing means for downsampling processing 511. The first downsampling processing means for downsampling processing 511 receives an input set of features x obtained from an input image data and down samples (performs downsampling processing) the set of features x. With downsampling the size of the input set of features x may be reduced. For example, the downsampling processing may involve processing by a downsampling convolutional block, a successively connected residual block and a second downsampling convolutional block that is connected to the output of the residual block in a neural network model described above.

The encoder 42 further includes a first filter means 512 for extracting a set of mixed features from an output of the first downsampling processing means for downsampling processing downsampling 511. The set of mixed features includes local and global features of the image data. The first filter means 512 may be implemented by the long and short attention module of the embodiment of the present application described above with reference to FIG. 1B. The encoder 42 further includes a second downsampling processing means for downsampling processing 513, which receives the extracted set of mixed features as its input and down samples (performs downsampling processing). The second downsampling processing means for downsampling processing 513 may be implemented by a first residual block, a downsampling convolutional block, a second residual block and a downsampling convolutional layer connected successively to each other.

The encoder 42 further includes a second filter means 514 for extracting latent representation of the input image data from an output of the second means for downsampling processing 513. The second filter means 514 may be implemented by the long and short attention module of the embodiment of the present application described above with reference to FIG. 1B. second filter means 514 extracts the latent representation of the input image data since the encoder 42 this embodiment of the present application is designed to learn important features of the input image data while reducing dimensionality. Since the encoder 42 may be a trained model, weights in the layers of the encoder 42 may be optimized to extract the latent representation of the input image data at the end of the encoder 42. In this regard, the second filter means 514 may extract the latent representation of the input image data while the first filter means 512 may extract only mixed features.

FIG. 5D shows a flowchart of a decoder for image data decompression according to the embodiment of the present application. The decoder 47 includes a first filter means 521. The first filter means 521 extracts features from an input set of features to be decompressed. The first filter means 521 may be implemented by the long and short attention module according to the embodiment of the present application described above with reference to FIG. 1B. In the decoder, it may be advantageous to have as many features as possible. Therefore, the long and short attention module of the embodiment of the present application may be used for extracting as many features as possible in the decoder to thereby help the decoder to more accurately reconstruct an image.

The decoder 47 further includes a first means for upsampling processing 522. The first upsampling processing means for upsampling processing 522 receives an output of the first filter means 521 and up samples (performs upsampling processing) the output of the first filter means 521. The first upsampling processing means for upsampling processing 522 may be included of a first residual block, a first upsampling convolutional residual block, a second residual block and a second convolutional residual block in a neural network model described above. Upsampling may result in increasing the size of the input set of features to be decompressed.

The decoder 47 further includes a second filter means 523. The second filter means 523 extracts features from an output of the first upsampling processing means for upsampling processing 522. The second filter means 523 may be implemented by the long and short attention module according to the embodiment of the present application described above with reference to FIG. 1B. The second filter means 523 implemented by the long and short attention module according to the embodiment of the present application may be used to help the decoder 47 to reconstruct more accurately an image by extracting as many features as possible features. Moreover, the decoder 47 further includes a second upsampling processing means for upsampling processing 524 from an output of the second filter means 523 to obtain a set of features representing the reconstructed image of the input set of features. The reconstructed image corresponds to a decompressed image of the input set of features to be decompressed. The second upsampling processing means for upsampling processing 524 may be included of a first residual block, a upsampling convolutional block, a second residual block and a upsampling convolutional layer successively connected to each other.

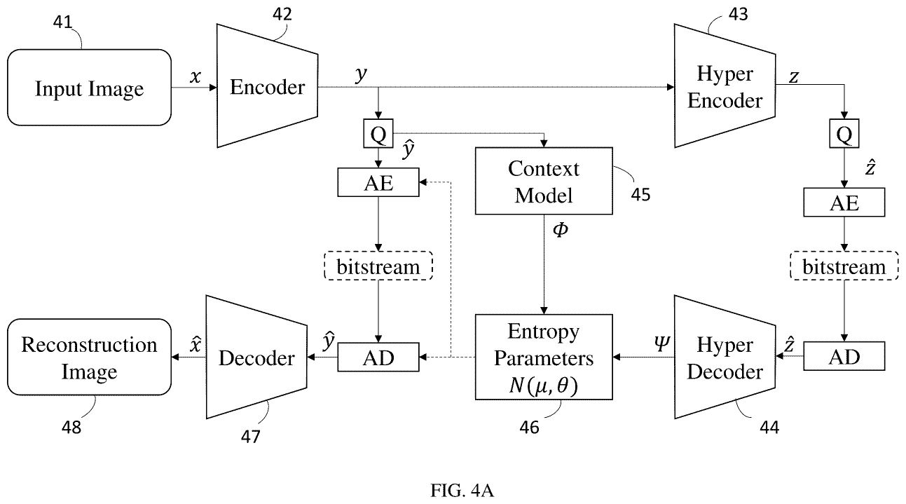

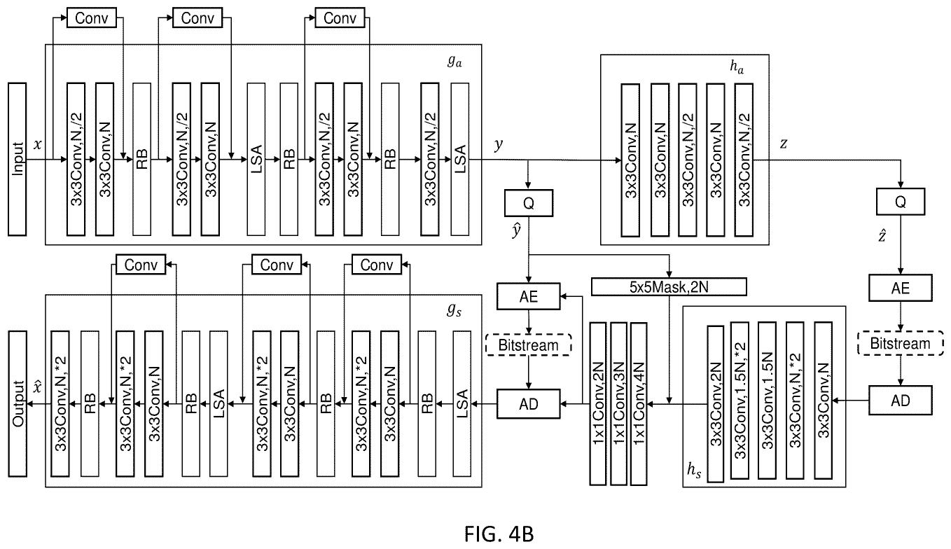

FIG. 4A shows a schematic view of a framework of the deep learning-based image compression and decompression according to an embodiment of the present application. The corresponding architecture of the neural network with an exemplary number of types and arrangement of the convolutional layers can be seen in FIG. 4B.

According to the present embodiment, there is provided a method for learned image processing using a neural network including performing the image compression by the encoder 42, providing the from the encoder 42 outputted extracted set of features y indicating a latent representation of the input image data in a first processing path and a second processing path and generating a reconstructed image by the decoder 47 using as an input set of features to be decompressed the output from the first and the second processing paths.

In the first processing path, a modeling information z is acquired by a hyper encoder 43 from the provided set of features indicating a latent representation y. Then, the modeling information z is quantized by a quantizer Q. The output is fed into an arithmetic coder (AE) and a bit stream is obtained fed into an arithmetic decoder (AE). The output of the arithmetic decoder (AD) representing the quantized modeling information \hat{z} is fed into a hyper decoder 44 and a decoded information Ψ is acquired by a hyper decoder 44 from the quantized modeling information \hat{z}.

In the second processing path, an auxiliary information Φ is obtained by a context model 45 from a quantized latent representation ŷ indicating a latent representation y quantized by a quantizer Q. Then, modeling parameters N(μ, θ) (entropy parameters) are calculated by an entropy model 46 by combining the decoded information Ψ and the auxiliary information Φ. The output of the quantizer Q is also fed into an arithmetic encoder (AE) that generates a bitstream fed into an arithmetic decoder (AD). The modeling parameters N(μ, θ) are fed to the arithmetic decoder (AD) and an output y of the arithmetic decoder (AD) from the modeling parameters N(μ, θ) is calculated. The modeling parameters N(μ, θ) are also fed to the arithmetic encoder (AE).

Hyper neural network, for example, the right side of the FIG. 4A and FIG. 4B, which consists of a hyper encoder and a hyper decoder may improve overall performance of a larger neural network by getting weights for the larger main neural network or by acting as a regularizer on the larger neural network.

In image compression, it may be required to make a trade-off between the bitrate size and the quality of the reconstructed image. A rate-distortion loss function and a mean square error may be used to optimize the proposed network. An example of the loss function may be defined as follows.

$$L = λ \cdot 25 {5}^{2} \cdot {D}_{M S E} + R$$

$$L = λ \cdot 25 {5}^{2} \cdot MS E ( \hat{x} , x ) + E [ - {log}_{2} ( {p}_{\hat{y} \vert \hat{z}} ( \hat{y} \vert \hat{z} ) ) ] + E [ - {log}_{2} ( {p}_{\hat{z} \vert ψ} ( \hat{z} \vert ψ ) ) ]$$

Parameter λ may be chosen between five choices of {0.0035, 0.0067, 0.015, 0.025, 0.0483} and the corresponding N in FIG. 4A is {128, 128, 128, 196, 196}.

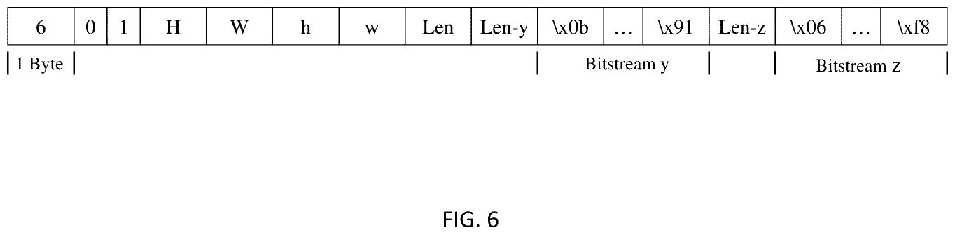

FIG. 6 shows a schematic view of a file format of a bitstream obtained by the image compression method according to an embodiment of the present application. The first byte is allocated to a method index. For example, the method index may be 6 based on CompressAI (see non-patent reference [8]). Following the method index, number of the optimization method and a quality number can be allocated in the bitstream file format. The quality number {1,2,3,4,5} may correspond to the five choices of λ {0.0035, 0.0067, 0.015, 0.025, 0.0483}, respectively. Then, the height of the original image H, the width of the original image W, a height of Gaussian model z (h), a width of Gaussian model z (w), a total length of the bitstream Len, a length of the image latent representation y encoded into the bitstream Len-y, a bitstream of the image latent representation y (\x0b . . . \x91), a length of a bitstream encoded with Gaussian modeling information z (Len-z) and the bitstream of Gaussian modeling information z (\x06 . . . \xf8) may be allocated in the bitstream file save format.

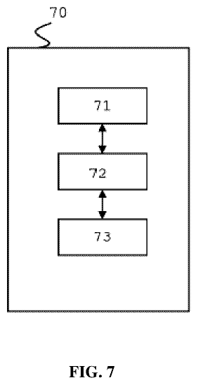

FIG. 7 shows a schematic view of a general device embodiment for applying any of the methods of the present application described above. The device 70 may include processing resources 71, a memory access 72 as well as a communication interface 73. The mentioned memory access 72 may store code or may have access to code that instructs the processing resources 71 to perform the one or more steps of any method embodiment of the present application as elaborated above and as described and explained in conjunction with the present disclosure. The communication interface 73 may be adapted for receiving communication data over a network. The network may be wired or wireless network. The device 70 can generally be a computer, a personal computer, a tablet computer, a notebook computer, a smartphone, a mobile phone, a video player, a tv set top box, a receiver, etc. as they are as such known in the arts.

The processing resources 71 may be embodied by one or more processing units, such as a central processing unit (CPU), or may also be provided by means of distributed and/or shared processing capabilities, such as present in a datacentre or in the form of so-called cloud computing.

The memory access 72 which can be embodied by local memory may include but not limited to, hard disk drive(s) (HDD), solid state drive(s) (SSD), random access memory (RAM), FLASH memory. Likewise, also distributed and/or shared memory storage may apply such as datacentre and/or cloud memory storage.

The communication interface 73 may be adapted for receiving data conveying the multiview picture data 10 as well as for transmitting communication data conveying the encoded at least one panoramic map of features and the plurality of encoded patches of view over a communication network. The communication network may be a wired or a wireless mobile network.

The embodiments of the present application described above achieve beneficial effects of the addressed technical problem. Technical effects of the embodiments may be shown in the several different tests. For example, tests for different QPs on traditional methods such as JPEG2000 (non-patent reference [2]) and VVC (VTM15.0) (non-patent reference [4]). Further, technical effects may be shown also in tests on several deep learning models provided by CompressAI (https://github.com/InterDigitalInc/CompressAI, non-patent reference [8]), including bmshj (non-patent reference [6]), mbt2018 (non-patent reference [9]) and Cheng2020 (without GMM) (non-patent reference [7]). Accordingly, in the following description the abbreviations “JPEG2000”, “VVC”, “CompressAI”, “bmshj” (or “bmshj2018”), “mbt2018” and “Cheng2020” or “Cheng” or Cheng (w.o. GMM) are used for referral to the non-patent references [2], [4], [8], [6], [9] and [7] respectively and the methods or codecs as well as models discussed therein and hence the JPEG2000 codec, VVC codec, bmshj2018 model, mbt2018 model and chang2020 model.

The performance of the models may be optimized with a mean square error under different λ. Furthermore, visual quality, PSNR (Peak to Signal Noise Ratio) and MS-SSIM (Multi-Scale Structural Similarity) may be used for performance comparison to verify the effectiveness of the long and short attention modules in bitrate saving.

For training the neural network the used hardware was TITAN X 12 G, the used software was Ubuntu 16.04.6, PyTorch 1.7.0 and the datasets comprise training dataset JPEG-AI Dataset (5283) and testing dataset JPEG-AI Dataset (40). The used evaluation metrics were PSNR: A high metric value expresses better image quality; MS-SSIM: A high metric value expresses better image quality; VMAF (Video Multi-Method Assessment Fusion): A higher score of this metric indicates better image quality; VIF (Visual Information Fidelity): A high score expresses better image quality; NLP: A lower score expresses better image quality; and FSIM (Feature Similarity Index): A high metric value expresses better image quality. The setting of the parameters was the following: Batch size: 8, Learning Rate: 1e-4, Epochs: 300.

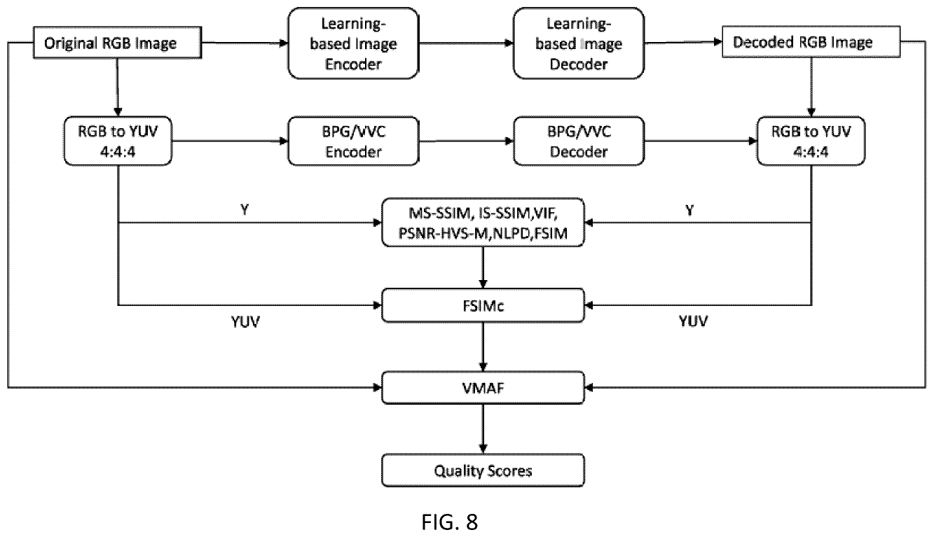

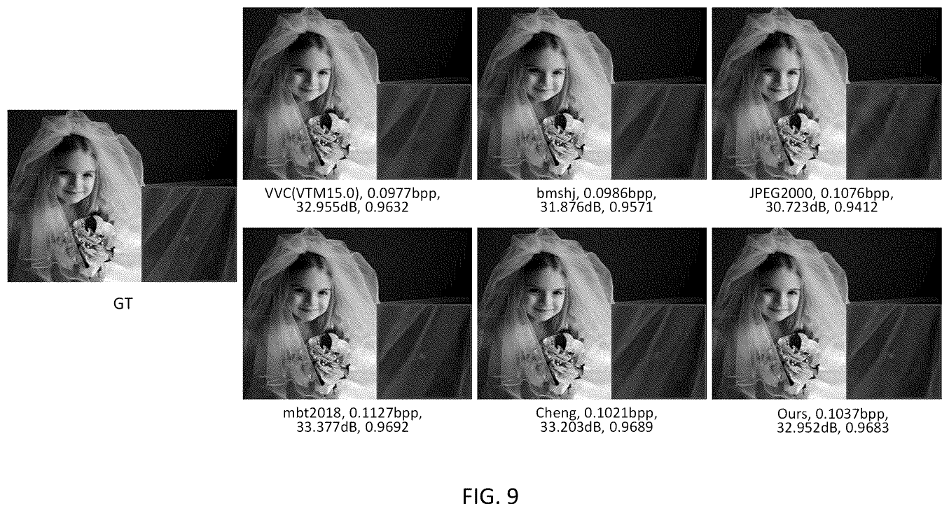

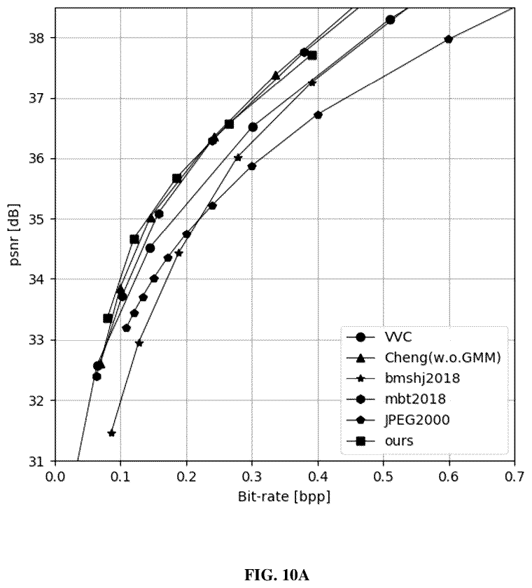

FIG. 8 shows more details of the testing procedure. For example, an original RGB image and a decoded RGB image that is encoded by the learning-based image encoder 42 and subsequently decoded by the learning-based image decoder 47 may be used to acquire quality scores. In detail, RGB images may be transformed in to YUV 4:4:4 which indicates full color depth. YUV color spaces may be more efficient in coding than RGB color models. Then, by taking multiple indexes which may indicate similarities such as MS-SSIM, IS-SSIM, VIF, PSNR-HVS-M, NLPD (Normalized Laplacian Pyramid Distance), FSIM, FSIMc and VMAF, the quality of reconstruction may be scored and accordingly compared in the quality score. FIG. 9 shows visual comparison among different methods in 00001-TE-960×720 of JPEG AI dataset. This figure shows a lot of details to reflect the visual compression effects of them. Bits per pixel (bpp), PSNR metrics and MS-SSIM metrics may be further provided for the decoded results.

In a test, JPEG2000 achieved the lowest PSNR value and MS-SSIM value, which indicates its compression effect was the worst. The proposed method outperformed bmshj and mbt2018 and was slightly worse than Cheng's result. In terms of evaluation metrics, VVC and Cheng were close in compression performance.

VVC (VTM15.0), JPEG2000 and bmshj caused a large detail loss, such as blurry edges of the wrinkled part in the red boxes (see the details of the white point). mbt2018 and Cheng have improved the reconstruction of the edges of the wedding dress (white spots are also reconstructed). And visually Cheng's reconstruction results were better than mbt2018's. The method for learned image processing of the present application recovered image details significantly better than other methods. Through visual comparison, the effectiveness of LSA module in image compression is verified.

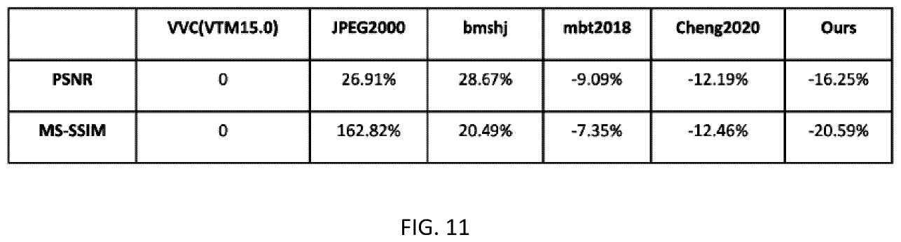

FIG. 11 shows a table of average bitrate savings over five A in comparison with VVC (VTM 15.0) anchor. For further comparison, average bitrate savings at bpp under [0.06, 0.50] with VVC (VTM15.0) may be calculated. Among them, JPEG2000, as an earlier traditional method, increased average 26.91% bitrate in PSNR and average 162.82% in MS-SSIM. Its compression effect was better than bmshj in PSNR with the worst performance in MS-SSIM. The average bitrate savings of bmshj were over 20%, and the performance was worse than VVC. mbt2018 saved about 10% bitrate and Cheng saved about 12% bitrate over VVC compression. The proposed method by the embodiments of the present application, marked as ‘Ours’ in the FIG. 11, achieved the largest bitrate savings with 16.25% in PSNR and 20.59% in MS-SSIM, while achieving the best compression efficiency on both metrics. Therefore, the results demonstrate the technical effectiveness of the long and short attention module in image compression.

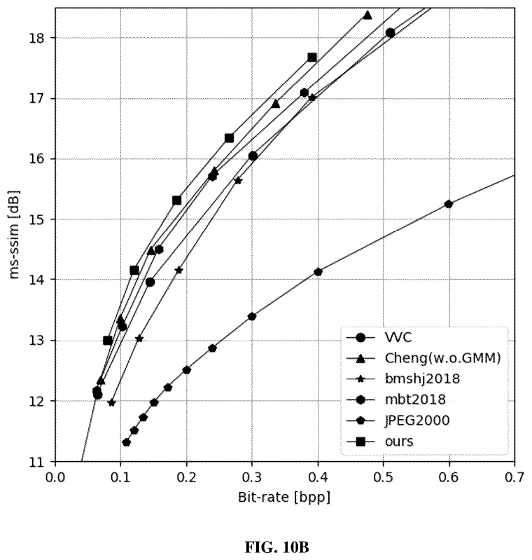

As another measure for comparison, rate-distortion curves may be used. The rate-distortion curves may reflect codec performance. FIGS. 10A & 10B show rate-distortion curves to compare codec performances between different methods. The legend item ‘ours’ refers to the proposed method by the embodiments of the present application. The horizontal axis represents the number of bits per pixel, and the vertical axis represents the evaluation metrics.

The rate-distortion curves in FIG. 10A clearly compare the PSNR performance of different methods at different bpp. At a low bitrate, the proposed method of the present application achieved the highest PSNR value, which indicates the best compression efficiency.

At a high bitrate, the proposed method of the present application achieved comparable performance to the methods of mbt2018 and Cheng (without GMM).

FIG. 10B compares the compression performance in terms of MS-SSIM metrics by various methods. MS-SSIM is converted into decibels to show the performance. It can be observed that the proposed method of the present application achieved the best performance in all bpps. The two rate-distortion curves presented in FIGS. 10A and 10B verified the effectiveness of the proposed method of the present application.

In summary, the present application proposes long and short attention module for feature extraction. The feature extraction may be utilized in learned image processing. As elaborated above, the long and short attention module has two branches. For learned image processing one branch extracts local features, while the other branch extracts global features. The global and local features are fused to obtain accurate latent features in an image. In the global feature branch, the proposed neural network architecture extracts multi-scale global features by the multi-head attention mechanism. The present application implements multi-scale global feature extraction using group convolutions between features to strengthen the ability of the long and short attention module to extract global features.

Further, the present application proposes a learned image compression neural network architecture that incorporates the long and short module into the auto-encoder so that the neural network can obtain the latent features of the image more accurately. Experiments show that the proposed network outperforms state-of-the-art methods at a low bitrate in PSNR. At a high bit rates, the proposed network achieves comparable performance to the others. In the MS-SSIM metric, the proposed method achieves the best performance (nest texture recovery), which indicates that the LSA module is good at reconstructing the structural information of images. In other words, the experiments verify that the accurate latent features of the image can improve the coding efficiency.

Although detailed embodiments have been described, these only serve to provide a better understanding of the present application defined by the independent claims and are not seen as limiting to the present application.

What is claimed is:

1. A method for feature extraction using a neural network, the method comprising:
extracting a first set of features from an input set of features by processing said input set of features through at least two residual blocks of the neural network connected successively to each other;
extracting a second set of features from the input set of features, said extracting the second set of features comprising the steps of:
extracting a third set of features and a fourth set of features from the input set of features by a non-local attention processing,
implementing a group convolution by a multi-head attention mechanism to the input set of features, the third set of features and the fourth set of features to obtain the second set of features.

2. The method of claim 1, wherein:
the input set of features is a multidimensional vector representing an image data.

3. The method of claim 2, wherein
the first set of features is a set of local features of the image data and the second set of features is a set of global features of the image data.

4. The method according to claim 1, comprising further the steps of:
obtaining a fifth set of features by processing the second set of features by at least two convolutional layers of the neural network.

5. The method according to claim 4, further comprising the steps of:
performing cascading processing on the first set of features and the fifth set of features, and
fusing the first set of features and fifth set of features after cascading processing to thereby obtain a mixed set of features.

6. The method according to claim 5, further comprising:
performing convolution processing on the mixed set of features by at least one convolutional layer of the neural network to obtain a sixth set of features, and
outputting the sixth set of features.

7. The method according to claim 1, wherein implementing the group convolution comprises the steps of:
multiplying the third set of features and the fourth set of features,
adding the input set of features to the multiplication of the third set of features and the fourth set of features to obtain a resultant set of features, and
concatenating the resultant set of features by the number of heads of the multi-head attention mechanism to obtain the second set of features.

8. The method according to claim 1, wherein extracting the third set of features comprises:
processing the input set of features through at least three residual blocks of the neural network successively connected to each other.

9. The method according to claim 1, wherein extracting the fourth set of features comprises:
processing the input set of features by at least three residual blocks of the neural network successively connected to each other;
processing the output of the last of the at least three residual blocks by a convolutional layer of the neural network; and
performing activation processing by an activation layer of the neural network to the output of the at least one convolutional layer.

10. A method for learned image compression using a neural network, the method comprising performing the steps of:
extracting a set of features (x) from an input image data to be compressed; and
extracting a set of features (y) indicating a latent representation of the input image data to be compressed from the set of features (x) extracted from the input image data to be compressed by performing the steps of:
performing at least four steps of downsampling convolution processing by at least four convolutional layers of the neural network arranged in a stream like manner on the extracted set of features (x) from the input image data, and
performing the steps of the feature extraction method of claim 1 at least once after two steps of downsampling convolution processing by two convolutional layers from the at least four convolutional layer by using as the input set of features a set of features based on the output of the second convolutional layer from the two convolutional layers to thereby extract the set of features (y) indicating the latent representation of the input image data; and
the method further comprising the step of:
outputting the extracted set of features (y) indicating a latent representation of the input image data.

11. The method of claim 10, further comprising:
inserting a step of processing by at least one residual block of the neural network at least between two steps of downsampling processing by two convolutional layers of the at least four downsampling convolutional layers arranged in a stream like manner.

12. A method for learned image decompression using a neural network, the method comprising:
extracting a set of features from an input set of features to be decompressed; and
extracting a set of features indicating a reconstructed image of the input image data from the extracted set of features by performing the steps of:
performing the steps of the feature extraction method of claim 1 using as the input set of features the extracted set of features from the input set of features to be decompressed,
performing upsampling convolution processing by at least four convolutional layers of the neural network arranged in a stream like manner on the extracted set of features from the input set of features to be decompressed, and
performing the feature extraction method of claim 1 at least once after two steps of upsampling convolution processing by two convolutional layers from the at least four convolutional layer by using as the input set of features a set of features based on the output of the second convolutional layer from the two convolutional layers to thereby extract a set of features indicating a reconstructed image of the input image data; and
the method further comprising:
outputting the extracted set of features indicating a reconstructed image of the input image data.

13. The method of claim 12, wherein the method further comprises:
inserting a step of processing by at least one residual block of the neural network at least once between two steps of upsampling processing by two convolutional layers of the at least four upsampling convolutional layers arranged in a stream like manner.

14. The method according to claim 1, wherein performing the step of processing by a residual block comprises:
performing convolution by at least two convolutional layers of the neural network;
performing activation by at least one activation layer of the neural network after each of the at least two convolutional layers of the neural network;
implementing a skip connection providing an alternative path from an input of the residual block to an output of the residual block; and
obtaining the output of the residual block by fusing the skip connection and the last activation layer of the residual block.

15. A non-transitory computer readable storage medium comprising instructions which, when executed by a computer, cause the computer to carry out the method of claim 1.

16. A non-transitory computer readable storage medium comprising instructions which, when executed by a computer, cause the computer to carry out the method of claim 10.

17. A non-transitory computer readable storage medium comprising instructions which, when executed by a computer, cause the computer to carry out the method of claim 12.
